(19) United States
(12) Patent Application Publication
(10) Pub. No.: US 2017/0287188 A1
(43) Pub. Date: Oct. 5, 2017

(54) METHOD AND APPARATUS FOR INTELLIGENTLY CAPTURING IMAGE

(71) Applicant: Beijing Xiaomi Mobile Software Co., Ltd., Beijing (CN)

(72) Inventors: Huayijun LIU, Beijing (CN); Tao CHEN, Beijing (CN); Ke WU, Beijing (CN)

(73) Assignee: Beijing Xiaomi Mobile Software Co., Ltd.

(21) Appl. No.: 15/469,705

(22) Filed: Mar. 27, 2017

(30) Foreign Application Priority Data
Mar. 31, 2016 (CN) 201610201760.8

(51) Int. Cl. G06T 11/60; G06T 3/00

(52) U.S. Cl. CPC G06T 11/60; G06T 3/0093

(57) ABSTRACT

The present disclosure relates to a method for intelligently capturing an image. The method includes acquiring an image captured by a camera, acquiring an obstacle in the image, erasing information within an obstacle region which corresponds to the obstacle, and repairing the obstacle region in which the information has been erased.

### CROSS-REFERENCE TO RELATED APPLICATION

The present application is based upon and claims priority to Chinese Patent Application No. CN201610201760.8 filed Mar. 31, 2016, the entire contents of which are incorporated herein by reference.

### TECHNICAL FIELD

The present disclosure generally relates to the field of image processing technology, and more particularly, to a method and an apparatus for intelligently capturing an image.

### BACKGROUND

Nowadays, with the rapid development of functions of electronic devices, users often capture images with electronic devices.

When a user captures an image, an obstacle often appears in the image. For example, when the user wants to capture a clear blue sky, a flying bird appears in the field of the camera. If the user wants an image of the blue sky without the flying bird, in this case the flying bird becomes an obstacle in the image, which bothers the user. In the related conventional art, the user can remove the obstacle from the image using image software in post-processing. However, it is burdensome and inefficient to remove the obstacle through the post-processing.

The method and apparatus of the present disclosure are directed towards overcoming one or more problems set forth above.

### SUMMARY

According to a first aspect of embodiments of the present disclosure, there is provided a method for intelligently capturing an image. The method includes acquiring an image captured by a camera, acquiring an obstacle in the image, erasing information within an obstacle region which corresponds to the obstacle, and repairing the obstacle region in which the information has been erased.

According to a second aspect of embodiments of the present disclosure, there is provided an apparatus for intelligently capturing an image. The apparatus includes a processor and a memory for storing instructions executable by the processor. The processor is configured to perform acquiring an image captured by a camera, acquiring an obstacle in the image, erasing information within an obstacle region which corresponds to the obstacle, and repairing the obstacle region in which the information has been erased.

According to a third aspect of embodiments of the present disclosure, there is provided a non-transitory computer-readable storage medium having stored therein instructions that, when executed by a processor in an apparatus, cause the apparatus to perform a method for intelligently capturing an image. The method includes acquiring an image captured by a camera, acquiring an obstacle in the image, erasing information within an obstacle region which corresponds to the obstacle, and repairing the obstacle region in which the information has been erased.

It is to be understood that both the foregoing general description and the following detailed description are exemplary only and are not restrictive of the present disclosure.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flow chart of a method for intelligently capturing an image according to an exemplary embodiment.

FIG. 2A is a flow chart of a method for intelligently capturing an image according to another exemplary embodiment.

FIG. 2B is a flow chart of a process for acquiring an obstacle in an image according to an exemplary embodiment.

FIG. 2C is a schematic diagram of a region in which an obstacle is present according to an exemplary embodiment.

FIG. 2D is a schematic diagram illustrating a process of erasing information within an obstacle region according to an exemplary embodiment.

FIG. 2E is a flow chart of a process for repairing an obstacle region in which information has been erased according to an exemplary embodiment.

FIG. 2F is a reference image for repairing an image according to an exemplary embodiment.

FIG. 2G is a repaired image resulted from repairing an image with a reference image according to an exemplary embodiment.

FIG. 2H(1) is an original image captured by a camera according to an exemplary embodiment.

FIG. 2H(2) is a repaired image corresponding to the original image of FIG. 2H(1) according to an exemplary embodiment.

FIG. 2I is a schematic diagram in which a delete control is displayed at a recognized object in an image according to an exemplary embodiment.

FIG. 2J is a schematic diagram in which a recognized object is displayed with a mark in an image according to an exemplary embodiment.

FIG. 3 is a block diagram of an apparatus for intelligently capturing an image according to an exemplary embodiment.

FIG. 4 is a block diagram of an apparatus for intelligently capturing an image according to another exemplary embodiment.

FIG. 5 is a block diagram of an apparatus for intelligently capturing an image according to yet another exemplary embodiment.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely exemplary apparatuses and methods consistent with aspects related to the invention as recited in the appended claims.

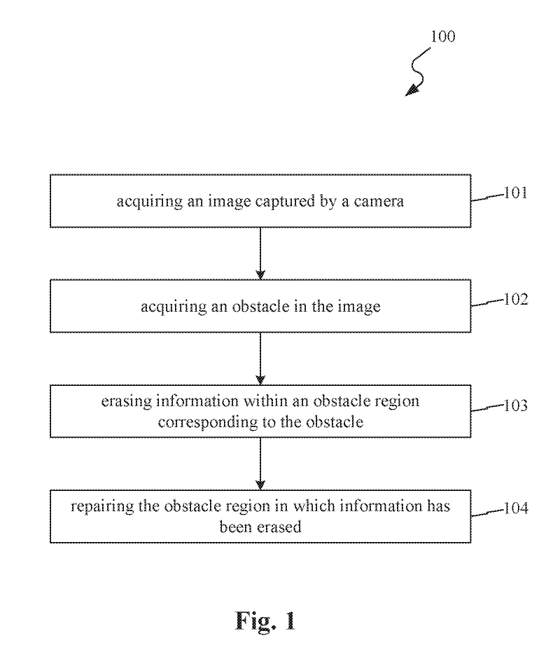

FIG. 1 is a flow chart of a method 100 for intelligently capturing an image according to an exemplary embodiment. The method 100 may be applied in an electronic device having a camera. The electronic device may be a smart mobile phone, a tablet computer, a video camera, a photographic camera or other devices with a capability of capturing an image. The method 100 may include the following steps.

In step 101, an image captured by a camera is acquired.

In step 102, an obstacle in the image is acquired.

In step 103, information within an obstacle region corresponding to the obstacle is erased.

In step 104, the obstacle region in which the information has been erased is repaired.

Accordingly, in the method 100 provided by the exemplary embodiments of the present disclosure, an image captured by a camera and an obstacle in the image are acquired, information within an obstacle region corresponding to the obstacle is erased, and the obstacle region is repaired after the information is erased. Since the obstacle in the image is automatically detected and erased by the electronic device, and the erased region in the image is automatically repaired by the electronic device, the obstacle in the image can be automatically removed when capturing an image. In this way, it can solve the problem associated with the related conventional art that the obstacle has to be removed in the post-processing of the image, thus simplifying operations of a user and improving the user experience.

According to some embodiments, an electronic device may provide a control to a user for intelligently capturing an image. The control for intelligently capturing an image may be configured to trigger the electronic device to enter a mode for intelligently erasing an obstacle. When the electronic device enters the mode for intelligently erasing an obstacle, the electronic device can erase an obstacle in an image being captured with a camera by the user, and can also erase an obstacle in an image already captured by the user.

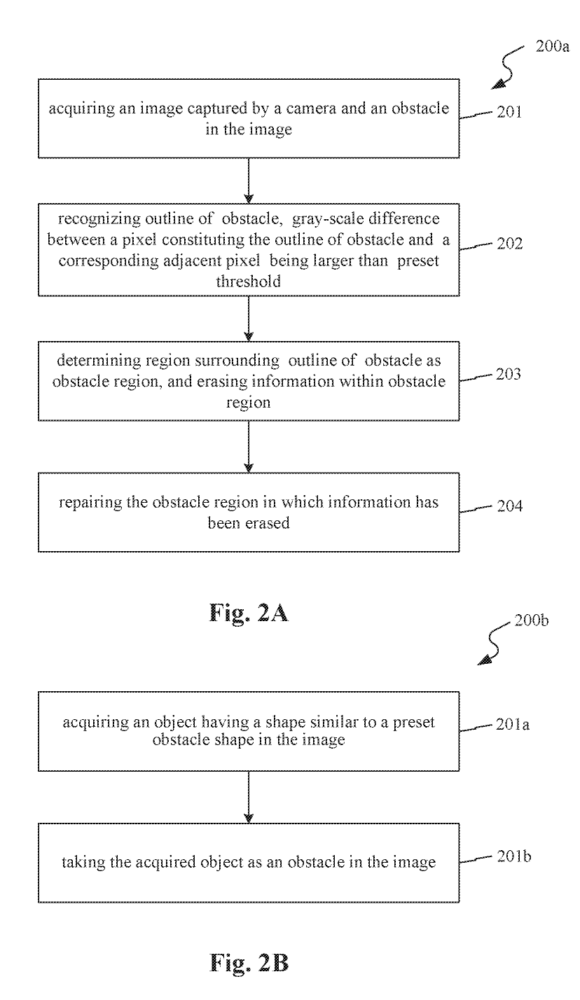

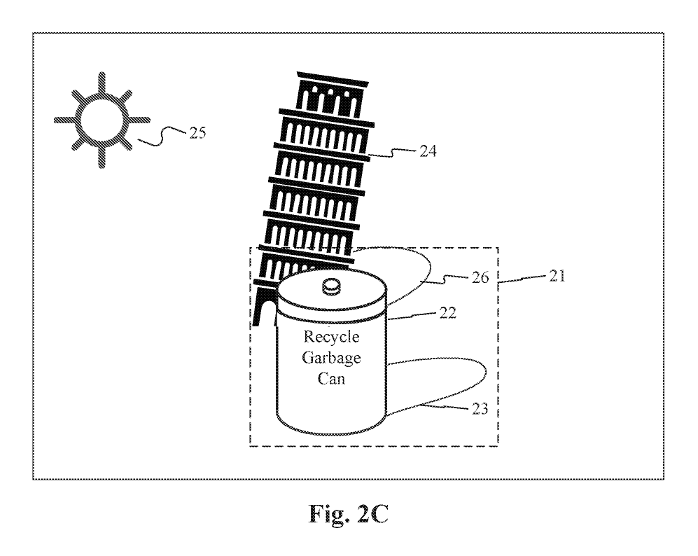

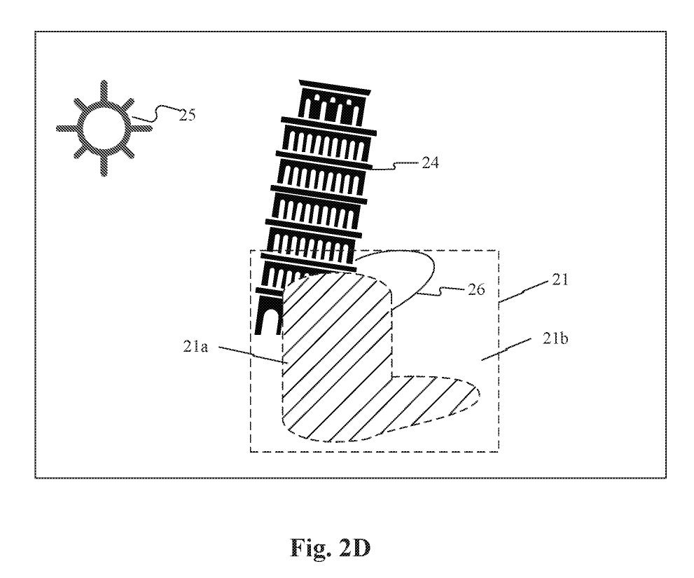

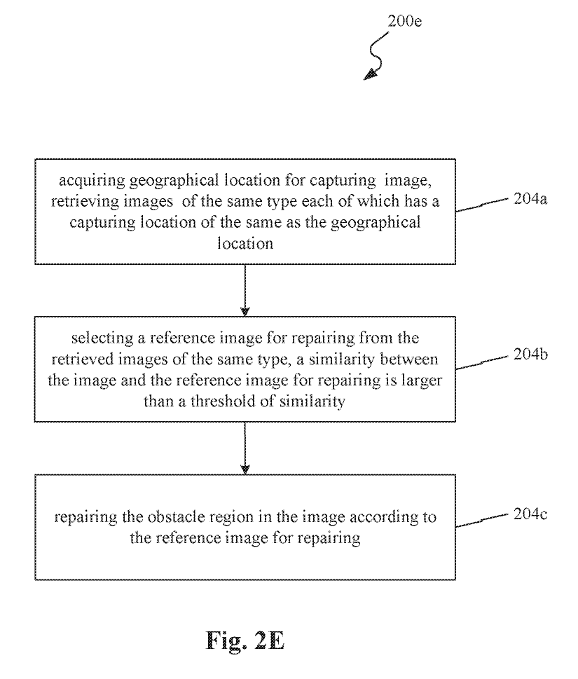

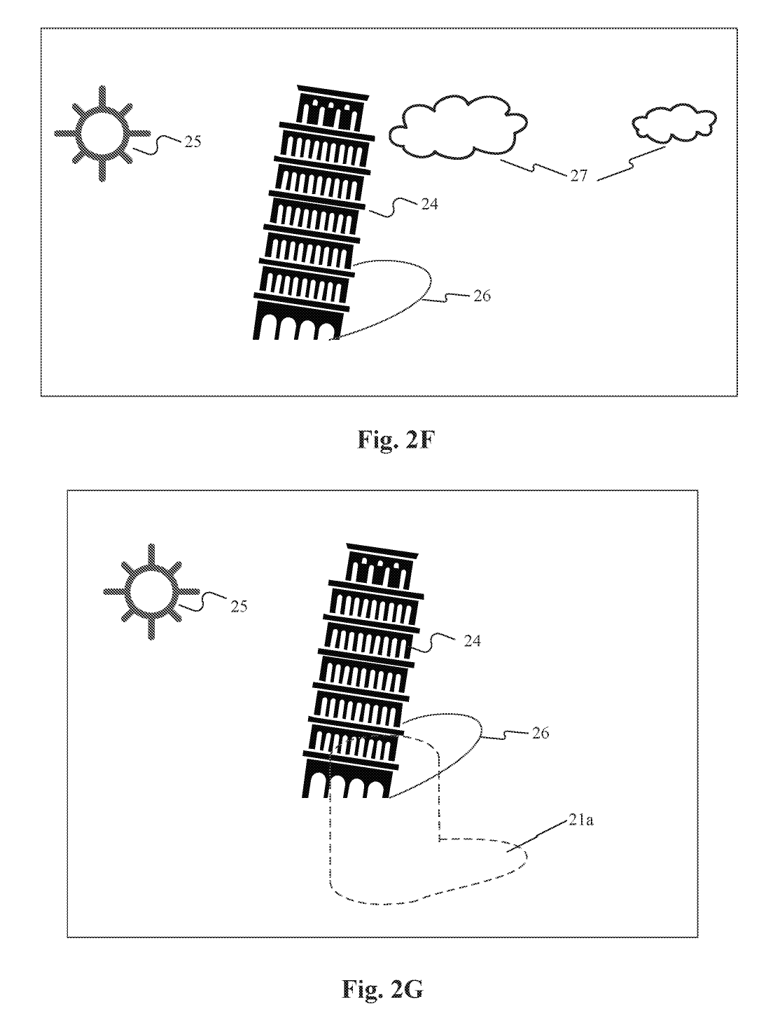

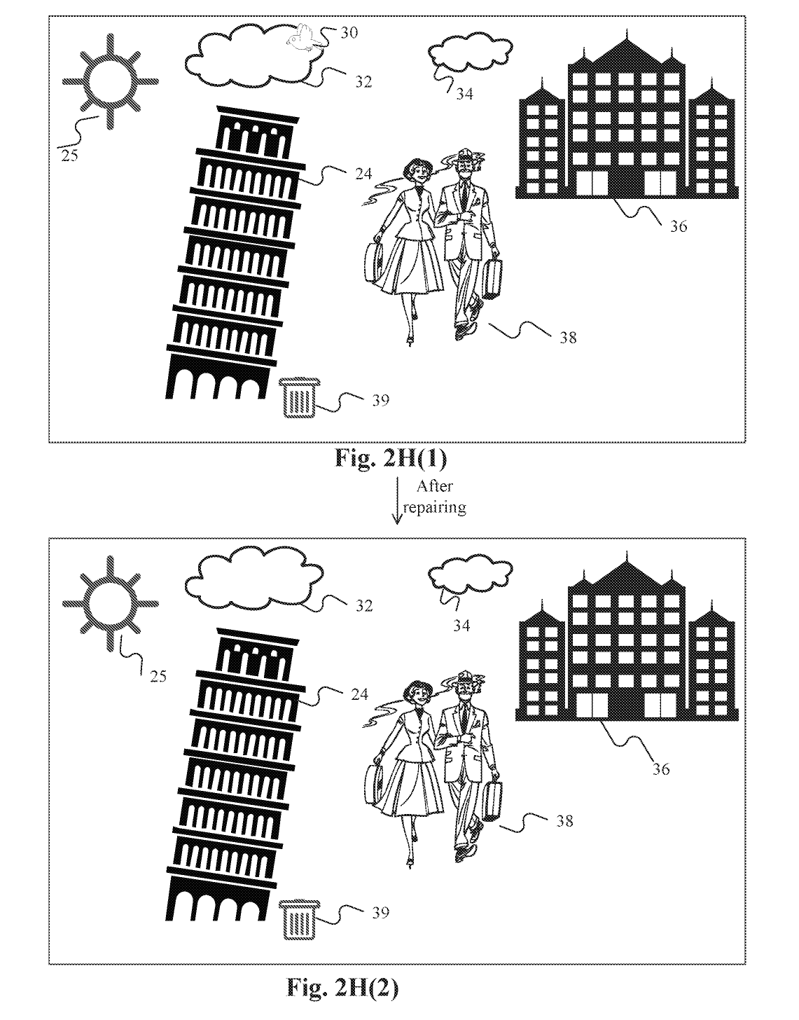

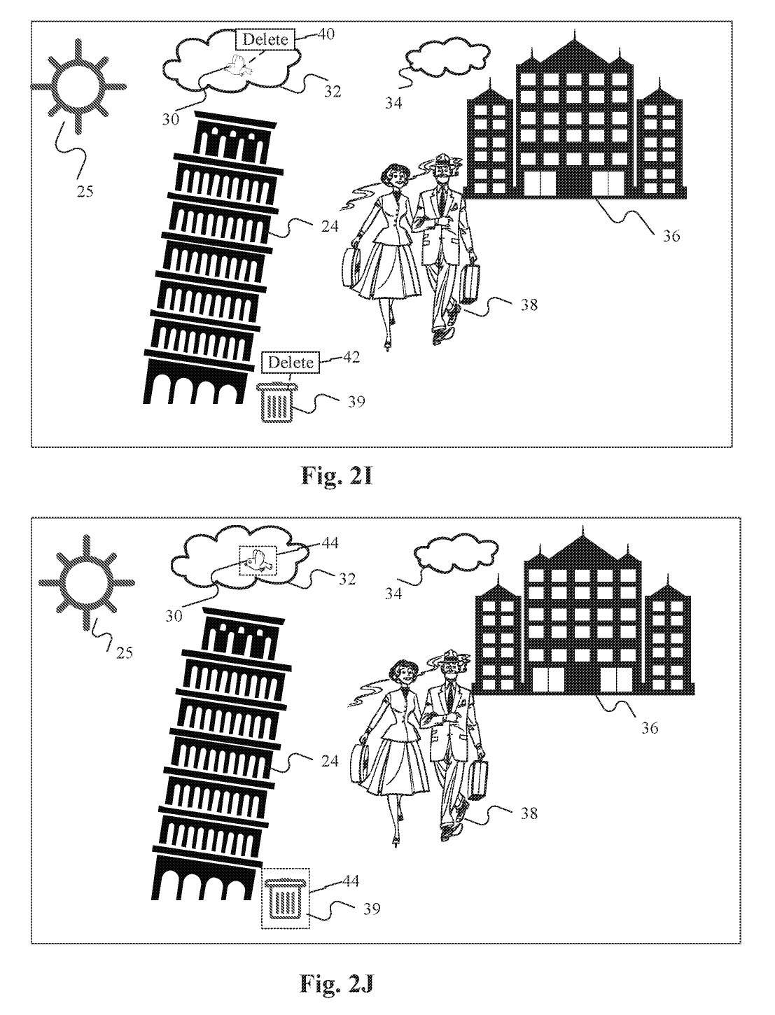

FIG. 2A is a flow chart of a method 200a for intelligently capturing an image according to another exemplary embodiment. The method 200a may be applied in an electronic device having a camera. The electronic device may be a smart mobile phone, a tablet computer, a video camera, a photographic camera or other devices with a capability of capturing an image. The method 200a may include the following steps.

In step 201, an image captured by a camera and an obstacle in the image are acquired.

In some embodiments, the obstacle in the image may be acquired through sub-steps shown in FIG. 2B in which a flow chart of a process 200b is illustrated for acquiring an obstacle in an image according to an exemplary embodiment.

In sub-step 201a, an object having a shape similar to a preset obstacle shape in the image is acquired.

The preset obstacle shape may be set by an electronic device system developer, or by a user. For example, the user may preset a wire mesh as an obstacle. In this case, the electronic device will acquire an object in the image having a shape similar to the shape of the wire mesh. Also for example, the user may preset a bird as an obstacle. In this case, the electronic device will acquire an object in the image having a shape similar to the shape of a bird. As another example, when an obstacle is set by the user, the user may set the shape of the obstacle to be a shape drawn by the user, or set the shape of the obstacle to be a shape of an object that has been set as an obstacle previously by the user.

In some embodiments, an object in the image which has a similarity to the preset obstacle shape larger than a preset threshold, may be acquired as the obstacle. Accordingly, for a same type of obstacles, the number of locally stored preset obstacle shapes corresponding to the same type of obstacles can be reduced. For example, a system developer sets a bird as an obstacle and, in such case, the electronic device may store several shapes of the bird in several postures as corresponding obstacle shapes, such as a shape of the bird while being flying, a shape of the bird while being resting, and so on.

In sub-step 201b, the acquired object is taken as an obstacle in the image.

Referring back to FIG. 2A, in step 202, an outline of the obstacle is recognized. Lines forming the outline of the obstacle may comprise pixels having a gray-scale different from a gray-scale of adjacent pixels. The difference in the gray-scale may be greater than a preset difference threshold.

In a region of the image where the obstacle is present, the outline of the obstacle is recognized. Specifically, in the region, a difference in gray-scale between each pixel and a corresponding adjacent pixel is calculated. A pixel which has a difference in gray-scale larger than a preset difference threshold is determined as a peripheral pixel. A line constituted by such peripheral pixels is the outline of the obstacle.

In the illustrated embodiments, the region where the obstacle is present refers to a region in the image which contains the obstacle. Generally, the region has a size that is the same as or slightly larger than the size of the shape of the obstacle, for example, a region 21 shown in FIG. 2C, which is a schematic diagram illustrating a region in which an obstacle is present according to an exemplary embodiment. If a system developer sets a recycle garbage can 22 as an obstacle, a region where the recycle garbage can 22 is present can be the region 21 in the image. Then, in a subsequent process, both of the recycle garbage can 22 and a shadow 23 of the recycle garbage can 22 may be considered as an obstacle region and erased. The shadow 23 may be formed under the Sun 25.

It should be noted that, the preset threshold of difference may be set by a system developer. The value of the preset threshold of difference is not specifically limited in the embodiments, and can be determined according to practical applications.

In step 203, a region surrounded by the outline of the obstacle is determined as an obstacle region, and information within the obstacle region is erased.

By determining the region surrounded by the outline of the obstacle as an obstacle region, it can avoid deleting regions beyond the obstacle region while the obstacle region being erased. For example, still referring to FIG. 2C, which shows an original image captured by a camera, after the outline of the obstacle (i.e., the recycle garbage can 22) is recognized in the region 21 of the image, a region surrounded by the outline of the obstacle is determined as the obstacle region, that is, a hatched region 21a as shown in FIG. 2D. FIG. 2D is a schematic diagram illustrating a process of erasing information within an obstacle region according to an exemplary embodiment. To erase information within the obstacle region, only the hatched region 21a in the FIG. 2D is to be erased, and a remaining region 21b in the region 21 will not be erased.

In step 204, the obstacle region in which information has been erased is repaired, which may be performed through the following sub-steps as shown in FIG. 2E. FIG. 2E is a flow chart of a process 200e for repairing an obstacle region in which information has been erased according to an exemplary embodiment.

In sub-step 204a, a geographical location for capturing the image is acquired, and images of the same type are retrieved. Each of the same type of images has a capturing location that is the same as the geographical location.

The geographical location may be acquired through various manners, such as a global positioning system (GPS), a Beidou navigation system or the like. The manner for acquiring the geographical location when capturing the image is not specifically limited in the present embodiment, and can be determined according to practical applications.

In the illustrated embodiments, the images having the same geographical location refer to images captured at the same geographical location and stored in a server. For example, if the geographical location when a user captures an image is at Tiananmen square in Beijing, images captured at Tiananmen square in Beijing and stored in a server are retrieved from the server. The images of the same type refer to images containing objects similar to the objects in the captured image.

For example, FIG. 2C is an original image captured by the user, and FIG. 2D is an image after the information of the obstacle region is erased. If the geographical location when the user captures the original image is around the Leaning Tower of Pisa 24 with a shadow 26, images stored in the server which have capturing locations around the Leaning Tower of Pisa 24 are retrieved. Since the original image captured by the user contains the Leaning Tower of Pisa 24, images containing the Leaning Tower of Pisa 24 are retrieved from the images which have capturing locations around the Leaning Tower of Pisa 24 in the server The images containing the Leaning Tower of Pisa 24 are considered as the images of the same type.

In sub-step 204b, a reference image for repairing is selected from the retrieved images of the same type. A similarity between the image to be repaired and the reference image is larger than a similarity threshold.

For each of the retrieved images of the same type, a similarity between each of the retrieved images and the original image captured by the camera is calculated. A retrieved image with a similarity larger than the similarity threshold is determined as a candidate reference image for repairing. A candidate reference image with a maximum similarity to the original image is determined as the reference image for repairing.

For example, the geographical location when the user captures the original image as shown in FIG. 2C is around the Leaning Tower of Pisa 24. From the retrieved images of the same type which have capturing locations around the Leaning Tower of Pisa 24 in the server, a reference image for repairing is selected, as shown in FIG. 2F. FIG. 2F is a reference image for repairing an image according to an exemplary embodiment. The reference image may also include sky clouds 27.

The similarity threshold may be set by the system developer. The value of the similarity threshold is not specifically limited in the embodiment, and can be determined according to practical applications.

In sub-step 204c, the obstacle region in the image is repaired according to the reference image for repairing.

Specifically, information for repairing is acquired from a region in the reference image which corresponds to the obstacle, and the obstacle region that has been erased in the original image is repaired with the information for repairing.

The region in the reference image for repairing which corresponds to the obstacle may be recognized with an image recognition technology. Pixels around the recognized region are the same as the pixels around the obstacle region in the original image. The image information of the recognized region is acquired as the information for repairing, and the obstacle region that has been erased in the original image is repaired with the information for repairing.

For example, the image of FIG. 2D after the image information in the obstacle region is erased can be repaired with the reference image in FIG. 2F, to obtain a repaired image as shown in FIG. 2G. In the image of FIG. 2G, the region having image information of the obstacle region repaired according to the reference image of FIG. 2F, is the region 21a.

Accordingly, in the methods for intelligently capturing an image provided by the embodiments of the present disclosure, an image captured by a camera and an obstacle in the image are acquired. Information within an obstacle region corresponding to the obstacle is erased, and the obstacle region is repaired after the information is erased. Since the obstacle in the image is automatically detected and erased by the electronic device, and the erased region in the image is automatically repaired by the electronic device, the obstacle in the image can be automatically removed when capturing the image. It can solve the problem in the related conventional art that the obstacle has to be removed in the post-processing of the image, thus simplifying operations of a user and improving the user experience.

In some embodiments, the obstacle region in which the information has been erased may be repaired by stretching and deforming a background around the obstacle region to fill the obstacle region.

For example, FIG. 2H(1) is an original image captured by a camera according to an exemplary embodiment, and FIG. 2H(2) is a repaired image corresponding to the original image of FIG. 2H(1) according to an exemplary embodiment. Specifically, in the original image shown in FIG. 2H(1), the user may set a bird 30 as an obstacle. In this case, an obstacle region corresponding to the bird 30 in the original image is acquired and information in the obstacle region is erased. In order to repair the obstacle region having the information erased, a background image around the obstacle region is acquired, for example, a white cloud 32 around the obstacle bird 30 is acquired from the original image. The white cloud 32 is stretched and deformed to a shape of the same as the shape of the obstacle region, to fill the obstacle region, resulting the repaired image as shown in FIG. 2H(2). In addition, FIGS. 2H(1) and 2H(2) may also include the Sun 25, the Leaning Tower of Pisa 24, a sky cloud 34, a building 36, persons 38, and a garbage can 39.

In some embodiments, an obstacle in an image may be acquired through the following manners.

In an exemplary implementation, if a difference in color between pixels of an object in the image and pixels of a background of the image is greater than a preset threshold, the object is acquired as an obstacle of the image.

That is to say, for each object in the image, a difference in color between pixels of the object and the pixels of the background is detected. If the difference in color between pixels is larger than a preset threshold, the object is taken as an obstacle. For example, if a user wants an image of a piece of white paper, and a captured image of the white paper has a black dot. In this case, the electronic device can detect that the difference in pixels between the black dot and the white background is larger than a preset threshold, and then determine the black dot as an obstacle of the captured image.

An object in an image can be determined through various manners, for example, by detecting edges of the image, to recognize an outline of the object constituted by edge lines. Recognizing an object in an image is known to those of ordinary skill in the art, which will not be elaborated in the embodiments.

In another exemplary implementation, an object with a shape similar to a preset obstacle shape may be acquired in an original image. The acquired object is displayed with a corresponding mark. If the object displayed with the mark is selected, the object is taken as the obstacle in the original image.

That is to say, a detected object with a shape similar to a preset obstacle shape in the original image is highlighted for a user to select. The object selected by the user will be taken as an obstacle.

In yet another exemplary implementation, if a difference in color between pixels of an object and pixels of a background of an original image is larger than a preset threshold, the object is acquired and displayed with a mark. If the object displayed with the mark is selected, the object is taken as an obstacle.

That is to say, if a difference in color between pixels of an object and pixels of a background of the image is larger than a preset threshold, the object is highlighted for the user to select, and the object selected by the user is taken as an obstacle.

In some embodiments, in situations where acquired objects are each displayed with a mark, and an object selected from the objects is taken as an obstacle, the following manners may be implemented.

In one exemplary implementation, a delete control is displayed at a recognized object in the original image. The object corresponding to a triggered delete control is determined as an obstacle in the original image.

For example, FIG. 2I is a schematic diagram in which a delete control is displayed at a recognized object in an image according to an exemplary embodiment. As shown in FIG. 2I, a system developer may set the bird 30 and the garbage can 39 as obstacles. The electronic device can recognize an object in the image having a shape corresponding to a preset shape of the bird 30 and/or a preset shape of the garbage can 39. A delete control 40 is displayed at an object recognized according to the preset obstacle shape of the bird 30, and a delete control 42 is displayed at an object recognized according to the preset obstacle shape of the garbage can 39. When it is detected that a delete control is triggered, the object corresponding to the triggered delete control is determined as an obstacle.

In another exemplary implementation, an obstacle in the image may be determined to be an object selected from objects displayed with a mark. The determined object may be recognized by triggering an extended-time press on the determined object.

For example, FIG. 2J is a schematic diagram in which a recognized object is displayed with a mark in an image according to an exemplary embodiment. As shown in FIG. 2J, a system developer may set the bird 30 and the garbage can 38 as obstacles. The electronic device can recognize an object in the image having a shape corresponding to a preset shape of the bird 30 and/or a preset shape of the garbage can 38. The recognized object is displayed with a mark, for example a dash-line box 44. The user can determine whether an object recognized by the electronic device is an obstacle according to the dash-line box 44. The user can select a recognized object to be erased and perform an extended-time press on it. Then, the electronic device can determine the recognized object triggered by the extended-time press as the obstacle in the image.

In some embodiments, an obstacle in an image may be acquired through the following manner: acquiring a selected region, extracting an outline of an obstacle in the selected region and taking a region surrounded by the outline of the obstacle as an obstacle region.

That is to say, a user may provide an obstacle region of the image manually. Specifically, the user can select a region in the image, and the electronic device can extract an outline of an obstacle within the selected region. The user may determine a region surrounded by the outline of the obstacle as the obstacle region.

In some embodiments, the outline of the obstacle which is extracted from the selected region may be added as a preset obstacle shape to a local library of preset shapes of obstacles, such that the electronic device may subsequently detect the obstacle designated by the user to be erased in the image and acquire the obstacle region.

The following are exemplary apparatus embodiments of the present disclosure, which may be configured to perform the above methods of the present disclosure. For details of the apparatus embodiments, reference can be made to the method embodiments of the present disclosure.

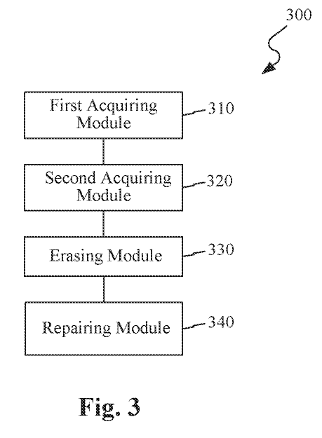

FIG. 3 is a block diagram of an apparatus 300 for intelligently capturing an image according to an exemplary embodiment. The apparatus 300 for intelligently capturing an image may be applied in an electronic device having a camera. The electronic device may be a smart mobile phone, a tablet computer, a video camera, a photographic camera or other devices with a capability of capturing an image. The apparatus 300 for intelligently capturing an image may include a first acquiring module 310, a second acquiring module 320, an erasing module 330 and a repairing module 340.

The first acquiring module 310 is configured to acquire an image captured by a camera.

The second acquiring module 320 is configured to acquire an obstacle in the image which is acquired by the first acquiring module 310.

The erasing module 330 is configured to erase information within an obstacle region which corresponds to the obstacle acquired by the second acquiring module 320.

The repairing module 340 is configured to repair the obstacle region in which information has been erased.

Accordingly, in the apparatus 300 for intelligently capturing an image provided by the exemplary embodiments of the present disclosure, an image captured by a camera and an obstacle in the image are acquired, information within an obstacle region corresponding to the obstacle is erased, and the obstacle region is repaired after the information is erased. Since the obstacle in the image is automatically detected and erased by the electronic device, and the erased region in the image is automatically repaired by the electronic device, it can automatically remove the obstacle in the image when capturing an image. It can solve the problem in the related conventional art that the obstacle has to be removed in the post-processing of the image, thus simplifying operations of a user and improving the user experience.

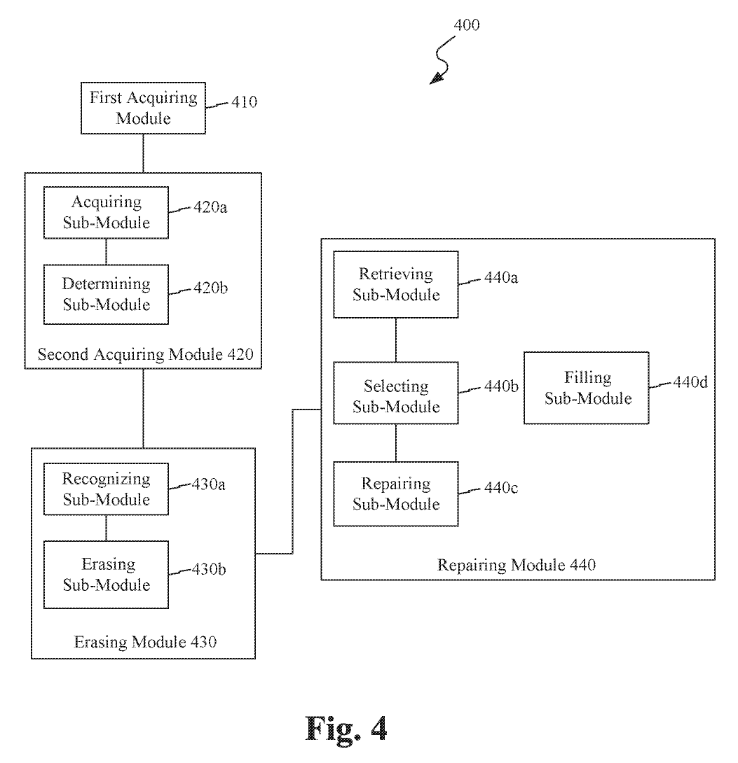

FIG. 4 is a block diagram of an apparatus 400 for intelligently capturing an image according to another exemplary embodiment. The apparatus 400 for intelligently capturing an image may be applied in an electronic device having a camera. The electronic device may be a smart mobile phone, a tablet computer, a video camera, a photographic camera or other devices with a capability of capturing an image. The apparatus 400 for intelligently capturing an image may include a first acquiring module 410, a second acquiring module 420, an erasing module 430 and a repairing module 440.

The first acquiring module 410 is configured to acquire an image captured by a camera.

The second acquiring module 420 is configured to acquire an obstacle in the image which is acquired by the first acquiring module 410.

The erasing module 430 is configured to erase information within an obstacle region which corresponds to the obstacle acquired by the second acquiring module 420.

The repairing module 440 is configured to repair the obstacle region in which information has been erased.

In some embodiments, the second acquiring module 420 may include an acquiring sub-module 420a and a determining sub-module 420b.

The acquiring sub-module 420a is configured to acquire an object having a shape similar to a preset obstacle shape in the image which is acquired by the first acquiring module 410, or acquire an object if a difference in color between pixels of the object and pixels of a background of the image acquired by the first acquiring module 410 is larger than a preset threshold.

The preset obstacle shape may be set by a system developer, or by a user. In some embodiments, an object may be acquired in the image, which has a similarity to the preset obstacle shape larger than a preset threshold, such that for a same type of obstacles, the number of locally stored preset obstacle shapes corresponding to the same type of obstacles can be reduced.

The determining sub-module 420b is configured to determine the object acquired by the acquiring sub-module 420a as the obstacle in the image. The determining sub-module 420b is also configured to display the object acquired by the acquiring sub-module 420a with a mark, and if the object displayed with a mark is selected, to determine the object as the obstacle in the image.

In some embodiments, the determining sub-module 420b is further configured to: display a delete control at the acquired object in the image, and if the delete control is triggered, to determine the acquired object corresponding to the trigged delete control as the obstacle in the image.

In some embodiments, the determining sub-module 420b is configured to display the acquired object with a mark in the image, and to determine the acquired object as the obstacle in the image if the acquired object is triggered by an extended-time press.

In some embodiments, the erasing module 430 may include a recognizing sub-module 430a and an erasing sub-module 430b.

The recognizing sub-module 430a is configured to recognize an outline of the obstacle. lines forming the outline of the obstacle may comprise pixels having a gray-scale different from a gray-scale of adjacent pixels. The difference in gray-scale may be greater than a preset threshold.

In a region of the image where the obstacle is present, the outline of the obstacle is recognized. Specifically, in the region, a difference in gray-scale between each pixel and a corresponding adjacent pixel is calculated. A pixel which has a difference in gray-scale larger than a preset threshold is determined as a peripheral pixel. A line constituted by such peripheral pixels is the outline of the obstacle.

The region where the obstacle is present refers to a region in the image which contains the obstacle. Generally, the region has a size that is the same as or slightly larger than the size of the shape of the obstacle.

It should be noted that, the preset threshold of difference may be set by a system developer. The value of the preset threshold of difference is not specifically limited in the embodiments, and can be determined according to practical applications.

The erasing sub-module 430b is configured to determine a region surrounded by the outline of the obstacle as an obstacle region, and to erase information within the obstacle region.

By determining the region surrounded by the outline of the obstacle as an obstacle region, it can avoid deleting regions beyond the obstacle region while the obstacle region being deleted.

In some embodiments, the repairing module 440 may include a retrieving sub-module 440a, a selecting sub-module 440b and a repairing sub-module 440c.

The retrieving sub-module 440a is configured to acquire a geographical location for capturing the image, and to retrieve images of the same type. Each of the retrieved images has a capturing location that is the same as the geographical location.

The geographical location may be acquired through various manners, such as a global positioning system (GPS), a Beidou navigation system or the like. The manner for acquiring the geographical location when capturing the image is not specifically limited in the present embodiment, and can be determined according to practical applications.

The images having the same geographical location refer to images captured at the same geographical location and stored in a server. For example, if the geographical location when a user captures an image is at Tiananmen square in Beijing, images captured at Tiananmen square in Beijing and stored in a server are retrieved from the server. The images of the same type refer to images containing objects similar to the objects in the captured image.

The selecting sub-module 440b is configured to select a reference image for repairing from the images of the same type retrieved by the retrieving sub-module 440a. A similarity between the image to be repaired and the reference image for repairing is larger than a similarity threshold.

For each of the retrieved images of the same type, a similarity between each of the retrieved images and the original image captured by the camera is calculated. An image with a similarity larger than the similarity threshold is determined as a candidate reference image for repairing. A candidate reference image with a maximum similarity to the original image is determined as the reference image for repairing.

The similarity threshold may be set by the system developer. The value of the similarity threshold is not specifically limited in the embodiment, and can be determined according to practical applications.

The repairing sub-module 440c is configured to repair the obstacle region in the image according to the reference image selected by the selecting sub-module 440b.

Specifically, information for repairing is acquired from a region in the reference image for repairing which corresponds to the obstacle, and the obstacle region that has been erased in the original image is repaired with the information for repairing.

The region in the reference image for repairing which corresponds to the obstacle may be recognized with an image recognition technology. Pixels around the recognized region are the same as the pixels around the obstacle region in the original image. The image information of the recognized region is acquired as the information for repairing, and the obstacle region that has been erased in the original image is repaired with the information.

In some embodiments, the repairing sub-module 440c may be further configured to: acquire information for repairing from a region corresponding to the obstacle in the reference image selected by the selecting sub-module 440b, and to repair the obstacle region in the image with the acquired information.

In some embodiments, the repairing module 440 may further include a filling sub-module 440d.

The filling sub-module 440d is configured to stretch and deform a background around the obstacle region to fill the obstacle region.

Accordingly, in the apparatus 400 for intelligently capturing an image provided by the exemplary embodiments of the present disclosure, an image captured by a camera and an obstacle in the image are acquired. Information within an obstacle region corresponding to the obstacle is erased, and the obstacle region is repaired after the information is erased. Since the obstacle in the image is automatically detected and erased by the electronic device, and the erased region in the image is automatically repaired by the electronic device, the obstacle in the image can be automatically removed when capturing the image. It can solve the problem in the related conventional art that the obstacle has to be removed in the post-processing of the image, thus simplifying operations of a user and improving the user experience.

In some embodiments, by displaying a delete control at a recognized object in the image, an object corresponding to a triggered delete control may be determined as the obstacle in the image. In some embodiments, by displaying a recognized object with a mark in the image, an object may be determined as the obstacle in the image if the object is triggered by an extended-time press. Since the electronic device can automatically highlight a recognized obstacle for a user, the user can select a region to be erased by triggering the region correspondingly. It can simplify the operation of determining an obstacle.

In some embodiments, by recognizing an outline of the obstacle, a region surrounded by the outline of the obstacle may be determined as an obstacle region. Information within the obstacle region is removed. The outline of the obstacle may comprise pixels having a gray-scale different from a gray-scale of adjacent pixels. The difference in gray-scale is greater than a preset threshold. It enables extracting an outline of an obstacle, determining a region to be erased according to the outline of the obstacle, i.e., an obstacle region, and erasing information within the region.

In some embodiments, by acquiring a geographical location where an image is captured, images of the same type may be retrieved, each of the retrieved images having a capturing location that is the same as the geographical location. A reference image for repairing the image may be selected from the retrieved images of the same type. A similarity between the image and the reference image is larger than a similarity threshold. An obstacle region in the image may be repaired according to the reference image. Since a reference image for repairing the image can be retrieved from images of the same type, and the obstacle region in the image can be repaired according to the reference image, the obstacle in the image can be intelligently erased to achieve a complete image containing no obstacle. Moreover, the repaired region can be resumed to a more realistic appearance, retaining a realistic presentation of the image.

In some embodiments, by acquiring repairing information from a region in the reference image which corresponds to the obstacle, the obstacle region in the image may be repaired with the repairing information.

In some embodiments, by stretching and deforming a background around the obstacle region, the obstacle region may be filled. In a case where images of the same type cannot be acquired to repair the obstacle region in the image, the obstacle region can be repaired by stretching and deforming the background of the image since the background of the image has similar contents. In this way, it can reduce the difference between the repaired obstacle region and the background.

In an exemplary embodiment of the present disclosure, an apparatus for intelligently capturing an image is provided, which may include a processor, and a memory for storing instructions executable by the processor. The processor is configured to perform: acquiring an image captured by a camera; acquiring an obstacle in the image; erasing information within an obstacle region which corresponds to the obstacle; and repairing the obstacle region in which information has been erased.

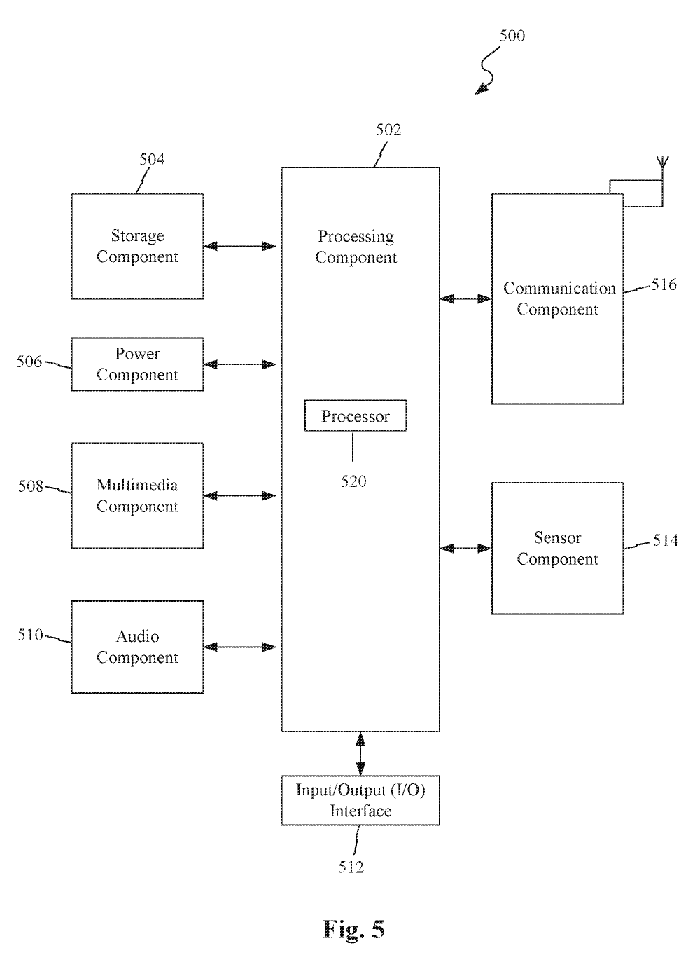

FIG. 5 is a block diagram of an apparatus 500 for intelligently capturing an image according to yet another exemplary embodiment. For example, the apparatus 500 may be a smart mobile phone, a tablet computer, a video camera, a photographic camera or other devices with a capability of capturing an image. The apparatus 500 may also be a computer, a digital broadcast terminal, a messaging device, a gaming console, a tablet, a medical device, exercise equipment, a personal digital assistant, and other devices with a capability of capturing an image.

Referring to FIG. 5, the apparatus 500 may include one or more of the following components: a processing component 502, a storage component 504, a power component 506, a multimedia component 508, an audio component 510, an input/output (I/O) interface 512, a sensor component 514, and a communication component 516.

The processing component 502 typically control overall operations of the apparatus 500, such as operations associated with display, telephone calls, data communications, camera operations, and recording operations. The processing component 502 may include one or more processors 520 to execute instructions to perform all or part of the steps in the above described methods. Moreover, the processing component 502 may include one or more modules which facilitate interactions between the processing component 502 and other components. For instance, the processing component 502 may include a multimedia module to facilitate interactions between the multimedia component 508 and the processing component 502.

The storage component 504 is configured to store various types of data to support operations of the apparatus 500. Examples of such data include instructions for any applications or methods operated on the apparatus 500, contact data, phonebook data, messages, pictures, video, etc. The storage component 504 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 506 provides power to various components of the apparatus 500. The power component 506 may include a power management system, one or more power sources, and any other components associated with the generation, management, and distribution of power in the apparatus 500.

The multimedia component 508 may include a screen providing an output interface between the apparatus 500 and a user. In some embodiments, the screen may include a liquid crystal display (LCD) and/or a touch panel (TP). If the screen includes the touch panel, the screen can be implemented as a touch screen to receive input signals from the user. The touch panel may include one or more touch sensors to sense touches, swipes, and gestures on the touch panel. The touch sensors can not only sense a boundary of a touch or swipe action, but also sense a period of time and a pressure associated with the touch or swipe action. In some embodiments, the multimedia component 508 may include a front camera and/or a rear camera. The front camera and the rear camera can receive an external multimedia datum while the apparatus 500 is in an operation mode, such as a photographing mode or a video mode. Each of the front camera and the rear camera may be a fixed optical lens system or have focus and optical zoom capability.

The audio component 510 is configured to output and/or input audio signals. For example, the audio component 510 may include a microphone (“MIC”) configured to receive an external audio signal when the apparatus 500 is in an operation mode, such as a call mode, a recording mode, and a voice recognition mode. The received audio signal can be further stored in the storage component 504 or transmitted via the communication component 516. In some embodiments, the audio component 510 may further include a speaker to output audio signals.

The I/O interface 512 provides an interface between the processing component 502 and peripheral interface modules, such as a keyboard, a click wheel, buttons, and the like. The buttons may include, but are not limited to, a home button, a volume button, a starting button, and a locking button.

The sensor component 514 may include one or more sensors to provide status assessments of various aspects of the apparatus 500. For instance, the sensor component 514 can detect an open/closed status of the apparatus 500, relative positioning of components, e.g., the display and the keypad, of the apparatus 500, a change in position of the apparatus 500 or a component of the apparatus 500, a presence or absence of user contact with the apparatus 500, an orientation or an acceleration/deceleration of the apparatus 500, and/or a change in temperature of the apparatus 500. The sensor component 514 may include a proximity sensor configured to detect the presence of nearby objects without any physical contact. The sensor component 514 may also include a light sensor, such as a CMOS or CCD image sensor, for imaging applications. In some embodiments, the sensor component 514 may also include an accelerometer sensor, a gyroscope sensor, a magnetic sensor, a pressure sensor, and/or a temperature sensor.

The communication component 516 is configured to facilitate wired or wireless communications between the apparatus 500 and other devices. The apparatus 500 can access a wireless network based on a communication standard, such as WiFi, 2G or 3G or a combination thereof. In one exemplary embodiment, the communication component 516 receives a broadcast signal from an external broadcast management system or broadcasts associated information via a broadcast channel. In one exemplary embodiment, the communication component 516 may further include a near field communication (NFC) module to facilitate short-range communications. For example, the NFC module can be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 500 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, a non-transitory computer-readable storage medium having instructions stored thereon is provided, such as included in the storage component 504. The instructions are executable by the processor 520 in the apparatus 500, for performing the above-described methods. For example, the non-transitory computer-readable storage medium may be a ROM, a RAM, a CD-ROM, a magnetic tape, a floppy disc, an optical data storage device, and the like.

Additionally, the instructions stored on the non-transitory computer readable storage medium, when executed by the processor 520 of the apparatus 500, cause the apparatus 500 to perform the methods illustrated in FIGS. 1, 2A, 2B and/or 2E.

It should be understood by those skilled in the art that the above described modules can each be implemented through hardware, or software, or a combination of hardware and software. One of ordinary skill in the art will also understand that multiple ones of the above described modules may be combined as one module, and each of the above described modules may be further divided into a plurality of sub-modules.

Other embodiments of the invention will be apparent to those skilled in the art from consideration of the specification and practice of the invention disclosed here. This application is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for intelligently capturing an image, comprising:
acquiring an image captured by a camera;
acquiring an obstacle in the image;
erasing information within an obstacle region which corresponds to the obstacle; and
repairing the obstacle region in which the information has been erased.

2. The method of claim 1, wherein acquiring the obstacle in the image comprises:
acquiring an object having a shape similar to a preset obstacle shape in the image, or acquiring an object when a difference in color between pixels of the object and pixels of a background of the image is larger than a preset threshold; and
determining the acquired object as the obstacle in the image.

3. The method of claim 1, wherein acquiring the obstacle in the image comprises:
acquiring an object having a shape similar to a preset obstacle shape in the image, or an object when a difference in color between pixels of the object and pixels of a background of the image is larger than a preset threshold;
displaying the acquired object with a mark; and
determining the acquired object as the obstacle in the image when the acquired object displayed with the mark is selected.

4. The method of claim 3, wherein:
displaying the acquired object with a mark comprises displaying a delete control at the acquired object in the image, and
determining the acquired object as the obstacle in the image when the acquired object displayed with the mark is selected, comprises: determining the acquired object corresponding to the delete control as the obstacle in the image when the delete control is triggered.

5. The method of claim 3, wherein determining the acquired object as the obstacle in the image when the acquired object displayed with the mark is selected comprises:
determining the acquired object as the obstacle in the image when the acquired object is triggered by an extended-time press.

6. The method of claim 1, wherein erasing information within an obstacle region which corresponds to the obstacle comprises:
recognizing an outline of the obstacle;
determining a region surrounded by the outline of the obstacle as the obstacle region; and
erasing the information within the obstacle region,
wherein:
the outline of the obstacle comprises pixels having a gray-scale different from a gray-scale of corresponding adjacent pixels; and
the difference in the gray-scale is larger than a preset threshold.

7. The method of claim 1, wherein repairing the obstacle region in which information has been erased comprises:
acquiring a geographical location where the image, as an original image, is captured;
retrieving images of a same type, each of the retrieved images having a same capturing location as the geographical location;
selecting a reference image for repairing the obstacle region from the retrieved images of the same type, a similarity between the original image and the reference image being larger than a similarity threshold; and
repairing the obstacle region in the original image according to the reference image.

8. The method of claim 7, wherein repairing the obstacle region in the original image according to the reference image comprises:
acquiring repairing information from a region in the reference image which corresponds to the obstacle; and
repairing the obstacle region in the original image with the repairing information.

9. The method of claim 1, wherein repairing the obstacle region in which information has been erased comprises:
stretching and deforming a background of the image around the obstacle region to fill the obstacle region.

10. An apparatus for intelligently capturing an image, comprising:
a processor; and
a memory for storing instructions executable by the processor;
wherein the processor is configured to perform:
acquiring an image captured by a camera;
acquiring an obstacle in the image;
erasing information within an obstacle region which corresponds to the obstacle; and
repairing the obstacle region in which the information has been erased.

11. The apparatus of claim 10, wherein the processor is further configured to perform:
acquiring an object having a shape similar to a preset obstacle shape in the image, or acquiring an object when a difference in color between pixels of the object and pixels of a background of the image is larger than a preset threshold; and
determining the acquired object as the obstacle in the image.

12. The apparatus of claim 10, wherein the processor is further configured to perform:
acquiring an object having a shape similar to a preset obstacle shape in the image, or acquiring an object when a difference in color between pixels of the object and pixels of a background of the image is larger than a preset threshold;
displaying the acquired object with a mark; and
determining the acquired object as the obstacle in the image when the acquired object displayed with the mark is selected.

13. The apparatus of claim 12, wherein the processor is further configured to perform:
displaying a delete control at the acquired object in the image, and
determining the acquired object corresponding to the delete control as the obstacle in the image when the delete control is triggered.

14. The apparatus of claim 12, wherein the processor is further configured to perform:
determining the acquired object as the obstacle in the image when the acquired object is triggered by an extended-time press.

15. The apparatus of claim 10, wherein the processor is further configured to perform:
recognizing an outline of the obstacle;
determining a region surrounded by the outline of the obstacle as the obstacle region; and
erasing the information within the obstacle region,
wherein:
the outline of the obstacle comprises pixels having a gray-scale different from a gray-scale of corresponding adjacent pixels; and
the difference in the gray-scale is larger than a preset threshold.

16. The apparatus of claim 10, wherein the processor is further configured to perform:
acquiring a geographical location where the image, as an original image, is captured;
retrieving images of a same type, each of the retrieved images having a same capturing location as the geographical location;
selecting a reference image for repairing the obstacle region from the retrieved images of the same type, a similarity between the original image and the reference image being larger than a similarity threshold; and
repairing the obstacle region in the original image according to the reference image.

17. The apparatus of claim 16, wherein the processor is further configured to perform:
acquiring repairing information from a region in the reference image which corresponds to the obstacle; and
repairing the obstacle region in the original image with the repairing information.

18. The apparatus of claim 10, wherein the processor is further configured to perform:
stretching and deforming a background of the image around the obstacle region to fill the obstacle region.

19. A non-transitory computer-readable storage medium having stored therein instructions that, when executed by a processor of an apparatus, cause the apparatus to perform a method for intelligently capturing an image, the method comprising:
acquiring an image captured by a camera;
acquiring an obstacle in the image;
erasing information within an obstacle region which corresponds to the obstacle; and
repairing the obstacle region in which the information has been erased.

20. The non-transitory computer-readable storage medium of claim 19, wherein acquiring the obstacle in the image comprises:
acquiring an object having a shape similar to a preset obstacle shape in the image, or acquiring an object when a difference in color between pixels of the object and pixels of a background of the image is larger than a preset threshold;
displaying the acquired object with a mark; and
determining the acquired object as the obstacle in the image when the acquired object displayed with the mark is selected.
